(19) United States
(12) Patent Application Publication
(10) Pub. No.: US 2009/0010187 A1
(43) Pub. Date: Jan. 8, 2009

(54) System and Method for an Adaptive Access Point Mode

(76) Inventors: Somesh Agarwal, Bangalore (IN); Frances Lee, San Jose, CA (US); Ilya Minkin, Los Altos, CA (US); Andrea Giuseppe Palisca, San Francisco, CA (US); Jeelan Poola, Proddatur (IN); Vinay Rajagopal, Bangalore (IN); Wanda Sealander, Bedford, NH (US); Ramesh Sekhar, San Jose, CA (US); Jacob Thomas, Kottayam (IN)

Correspondence Address: FAY KAPLUN & MARCIN, LLP, 150 BROADWAY, SUITE 702, NEW YORK, NY, 10038, US

(21) Appl. No.: 12/051,259

(22) Filed: Mar. 19, 2008

Related U.S. Application Data
(60) Provisional application No. 60/948,430, filed on Jul. 6, 2007.

(51) Int. Cl. H04B 7/00

(52) U.S. Cl. 370/310

(57) ABSTRACT

A system an adaptive access point node includes (a) a switch disposed within a network, the network comprising at least one virtual local area network; (b) an anchor access point disposed in the at least one virtual local area network, the anchor access point connected to the switch via a data path, the anchor access point configured to receive a broadcast data packet from the switch via the data path; and (c) at least one access point connected to the anchor access point via a local data path to receive the broadcast data packet from the anchor access point via the local data path. The anchor access point and the access points further forward the broadcast data packet to other devices connected thereto.

### PRIORITY CLAIM

This application claims the priority to the U.S. Provisional Application Ser. No. 60/948,430, entitled “System and Method for an Adaptive Access Point Mode,” filed Jul. 6, 2007. The specification of the above-identified application is incorporated herewith by reference.

### FIELD OF THE INVENTION

The present invention relates generally to a system and method for an adaptive access point mode. Specifically, an access point is designated as an anchor access point to act in a substantially similar manner as a switch.

### BACKGROUND INFORMATION

A wireless switched network utilizes a switch to transmit data between various network components. The switch may be capable of inspecting data packets as they are received, determining the source and destination device of the packet, and forwarding the packet appropriately. Thus, thin access points (AP) may be used to extend an operating area of the network. Thin APs may be equipped with less intelligent components than conventional APs. However, despite requiring less cost, thin APs may only forward data to be exchanged within the network.

Although the switch is designed to intelligently distribute broadcast data packets, data loops may be created due to interconnections within a virtual local area network (VLAN) and/or a local area network (LAN). For example, when APs in the VLAN are all connected to the switch, the broadcast data packets may be sent from the switch to each of the APs. The broadcast data packets may be automatically sent to all devices connected to the AP by means of the port to which the devices are connected. However, the APs in the VLAN may be interconnected with one another. Thus, every AP may receive the same broadcast data packet repeatedly by being resent from each of the APs. Therefore, any edge device may potentially receive an infinite number of the same data packet.

### SUMMARY OF THE INVENTION

The present invention relates to a system and method for an adaptive access point node. The system includes (a) a switch disposed within a network, the network comprising at least one virtual local area network; (b) an anchor access point disposed in the at least one virtual local area network, the anchor access point connected to the switch via a data path, the anchor access point configured to receive a broadcast data packet from the switch via the data path; and (c) at least one access point connected to the anchor access point via a local data path to receive the broadcast data packet from the anchor access point via the local data path. The anchor access point and the access points further forward the broadcast data packet to other devices connected thereto.

The method according to the present invention includes the following steps: (a) transmitting, from a switch, a broadcast data packet to an anchor access point of a network, the anchor access point being included in a virtual local area network, the virtual local area network being a part of the network; and (b) forwarding, from the anchor access point, the broadcast data packet to devices connected thereto.

### DESCRIPTION OF THE DRAWINGS

FIG. 1 shows a system of a switched network according to an exemplary embodiment of the present invention.

FIG. 2 shows a wide area network including virtual local area networks according to an exemplary embodiment of the present invention.

FIG. 3 shows a method of transmitting data through the switched network of FIG. 1 according to an exemplary embodiment of the present invention.

FIG. 4 shows a mesh topology for a switched network according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method of extending a virtual local area network (VLAN) by preventing issues arising when conventionally attempting to extend the VLAN. In particular, the exemplary embodiments of the present invention provide a configuration for a wireless switched network that may be divided into at least one VLAN. The VLAN includes an anchor access point (AAP) that is further connected to other access points (AP). The switched network, VLANs, the AAP, and the APs will be described in detail below.

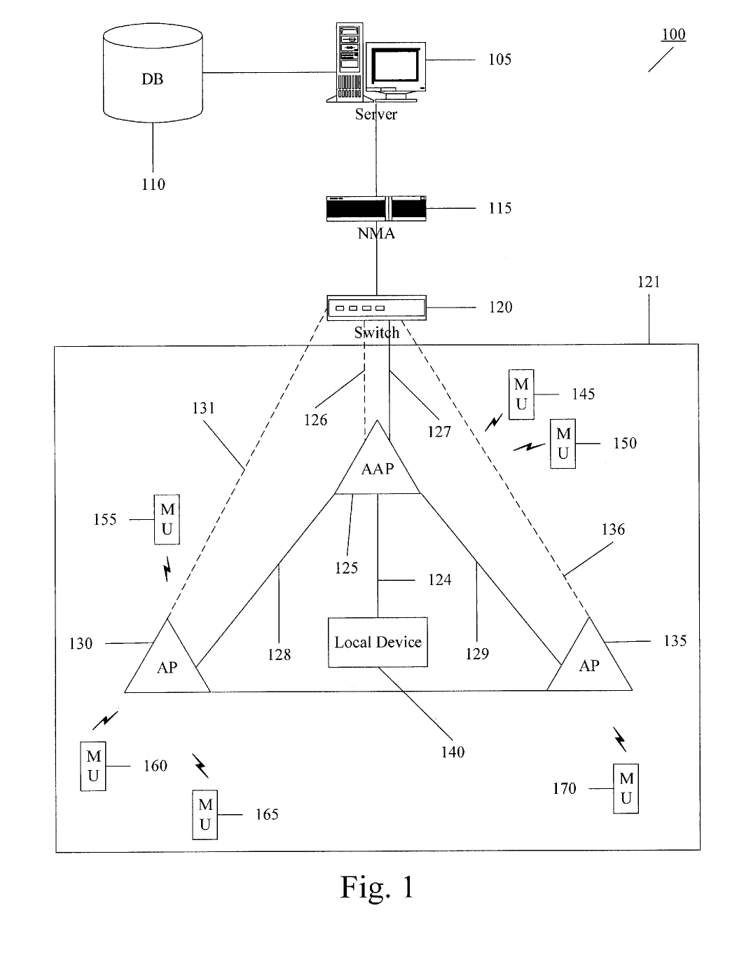

FIG. 1 shows a system 100 for a wireless switched network according to an exemplary embodiment of the present invention. A server 105 may be responsible for maintenance of the wireless switched network. The server 105 may be connected to or include a database 110. A network management arrangement (NMA) 115 may be connected to the server 105. Because the system 100 is for a wireless switched network, a switch 120 may be connected to the NMA 115. It should be noted that the NMA 115 disposed between the server 105 and the switch 120 is only exemplary. Those skilled in the art will understand that the server 105 may be directly connected to the switch 120. It should also be noted that the use of the NMA 115 is only exemplary. Those skilled in the art will understand that depending on the size of the wireless switched network, a plurality of NMAs 115 may be disposed or the system 100 may not utilize the NMA 115.

According to the exemplary embodiments of the present invention, a VLAN 121 may exist within the system 100. That is, the wireless switched network may be the VLAN 121. The VLAN 121 may include a variety of components. The VLAN 121 may be a portion of the overall wide area network (WAN) in which the server 105, NMA 115, and the switch 120 are included. It should be noted that the VLAN 121 may include components that may be selected by a variety of conditions. For example, the VLAN 121 may include a set of components based on a location. Thus, the components may be localized in an area. In another example, the VLAN 121 may include a set of components based on time. Thus, the components may be determined based on when the device was introduced into the network. In yet another example, the VLAN 121 may include a set of components based on an available connectivity. Thus, the components may be selected based on a location and/or operating area of other components. As illustrated, the VLAN 121 may include an AAP 125, APs 130, 135, a local device 140, and mobile units (MU) 145-170.

As illustrated, the AAP 125 may be connected to the switch 120. The AAP 125 may communicate with the switch 120 using a wired connection. Those skilled in the art will understand that the physical connection between the AAP 125 and the switch 120 may be either via a WAN port or a LAN port. Those skilled in the art will also understand that the AAP 125 may communicate with the switch 120 using a wireless connection. The AAP 125 may be a specialized AP. That is, the AAP 125 may include all the functionalities attributed to the APs in the VLAN but further includes additional functionalities.

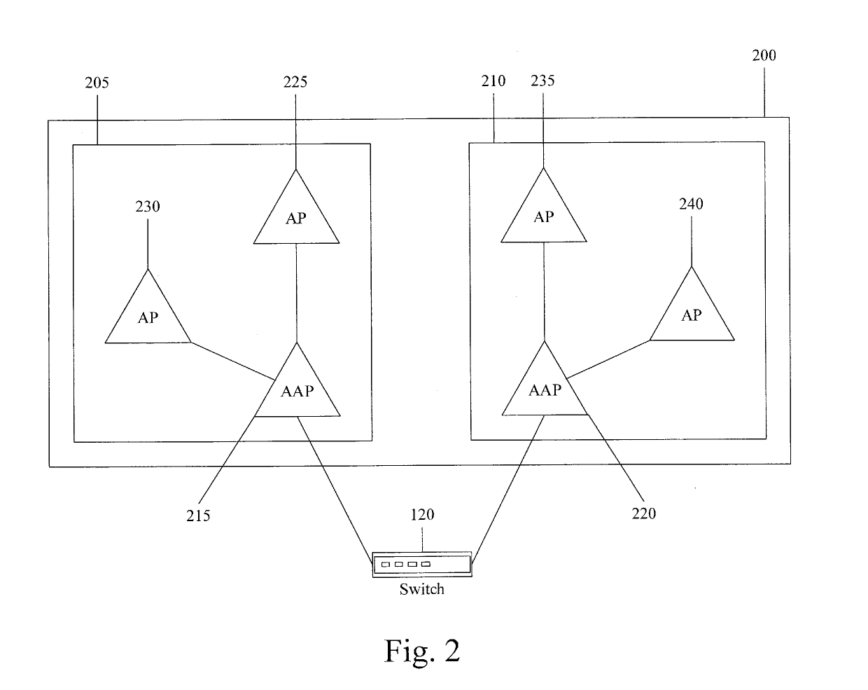

According to the exemplary embodiment, the AAP 125 may serve as a pseudo-switch. The AAP 125 may be responsible for distribution of broadcast data packets for the VLAN 121. Each site of a network may include an AAP functioning substantially similar to the AAP 125. An exemplary network with more than one AAP will be described with reference to FIG. 2. As a wireless switched network, the AAP 125 may wirelessly communicate with the MUs 145, 150. The APs 130, 135 may be connected to each other and may be connected to the AAP 125. The APs 130, 135 may communicate with each other and to the AAP 125 using a wired and/or wireless connection. This communication may be a local data path so that data may be transmitted within the VLAN. The AP 130 may wirelessly communicate with the MUs 155-165 while the AP 135 may wirelessly communicate with the MU 170. The VLAN 121 may also include a local device 140. The local device 140 may be, for example, a printer, a workstation, a fax machine, a telephone, a scanner, etc. As illustrated, the local device 140 may communicate with the AAP 125 using a wired connection. Similarly, the MUs may also communicate with the local device 140 if they are mapped to the same VLAN.

The APs 130, 135 may include a control path to the switch 120. The AP 130 may communicate with the switch 120 using a control path 131 while the AP 135 may communicate with the switch 120 using a control path 136. The control paths 131, 136 may be used for transmitting and/or receiving control packets. The APs 130, 135 may create a wireless switch protocol-hybrid (WISP-H) control packet that includes configuration and statistics data. Using the control paths 131, 136, the WISP-H control packet may be securely transmitted to the switch 120. Subsequently, the switch 120 may determine, for example, overall performance information as well as individual performance information regarding each AP. The switch 120 may also configure the VLANs on the remote network.

The AAP 125 may also include a control path 126. The control path 126 may be used to securely transmit the WISP-H control packet regarding the AAP 125. That is, the control path 126 may function substantially similar to the control paths 131, 136. It should be noted that the use of the WISP-H control packets is only exemplary. The APs 130 and 135 and the AAP 125 may use any type of protocol packets to communicate control information to the switch 120.

In addition, the AAP 125 may include a data path 127 to the switch 120. The data path 127 may be a virtual private network (VPN) tunnel. The VPN tunnel may be responsible for receiving broadcast data to be distributed to the components of the VLAN 121. Thus, because the AAP 125 solely has the data path 127 to the switch 120, any broadcast data from the switch must first reach the AAP 125. That is, each AAP may include a WAN or LAN data path to the switch. Each AAP may also include a LAN data path to the APs in the VLAN.

The VLAN 121 including a single AAP 125 and, therefore, a single data path 127 to the switch 120 prevents any potential data loops from occurring. That is, since the VLAN 121 includes at least two APs (AAP 125, APs 130, 135), the use of the AAP 125 prevents the above described data loops since a broadcast data packet from the switch 120 will only be transmitted to the AAP 125 through the VPN tunnel 127 which may be created via the WAN port or the LAN port, instead of all of the APs. Because the AAP 125 is further connected to the APs 130, 135 and the local device 140, the AAP 125 may forward the broadcast data packet to each device connected thereto using the LAN data path. Thus, the APs 130, 135 receive the broadcast data packet via LAN data paths 128 and 129, respectively; the local device 140 receives the broadcast data packet via LAN data path 124; and the MUs 145, 150 receive the broadcast data packet wirelessly from the AAP 125. The APs 130, 135 may then forward the data packet to devices connected thereto. Thus, the MUs 155-165 may receive the data packet from AP 130; and the MU 170 may receive the data packet from the AP 135.

FIG. 2 shows a WAN 200 including VLANs 205, 210 according to an exemplary embodiment of the present invention. The VLANs 205 210 may also be created using location as a basis. However, it should again be noted that the VLANS 205, 210 may be created using other bases such as connection time and available connectivity. The VLAN 205 may include an AAP 215 and APs 225, 230. The VLAN 210 may include an AAP 220 and APs 235, 240.

Substantially similar to the description described above with the system 100, the switch 120 may be connected to each of the AAPs 215, 220 of the VLANs 205, 210, respectively, through a WAN data path or VPN tunnel. However, it should be noted that the connections shown in FIG. 2 illustrate only the data paths in which data packets are transmitted. That is, the AAPs 215, 220 and the APs 225-240 may also be connected to the switch 120 with control paths (not shown) in which WISP-H (or other types of) control packets are transmitted.

As illustrated, when the switch 120 transmits a broadcast data packet, the packet may be sent to the AAPs 210, 215 using the data paths. That is, the switch 120 does not transmit the packet to each of the APs 225-240 of the VLANs 205, 210. The AAPs 210, 215 are the only components that are configured to receive the packet (via their respective data VPN tunnel connection to the switch 120). Thus, once the switch 120 sends the packet to the AAPs 210, 215, the AAPs 210, 215 may then forward the packet to each of the connected devices thereto using the LAN data paths (as illustrated). For example, the AAP 210 may forward the packet to the APs 225, 230 while the AAP 215 may forward the packet to the APs 235, 240. It should be noted that a plurality of MUs (not shown) may be disposed in each of the VLANs 205, 210. The MUs may be connected to any of the AAPs 215, 220 or the APs 225-240. Thus, the AAPs 215, 220 may also forward the packet to any MU connected thereto. Upon receiving the packet from the AAPs 215, 220, the APs 225-240 may also forward the packet to any MU connected thereto. In addition, local devices may be disposed within the VLAN 205 and/or the VLAN 210. The local devices may be connected to the switch 120, the AAPs 215-220, or the APs 225-240. Depending on which component in which the local device is connected, the local device may also receive the broadcast data packet.

It should be noted that further APs may be disposed within the VLANs 205, 210. The further APs may be connected within the VLANs 205, 210 through the APs 225, 230 and the APs 235, 240, respectively. That is, the further APs may not be directly connected to the AAPs 215, 220. In a first embodiment, the further APs may be connected to the switch 120 via the control path to transmit the WISP-H control packets. In a second embodiment, the WISP-H control packets may be transmitted from the further APs to one of the APs connected to the AAP. Thus, the WISP-H control packets of the further APs may be transmitted to the switch 120 via any AP that has a control path to the switch 120. It should be noted that the WISP-H control packets are unique to the AP in which it originates.

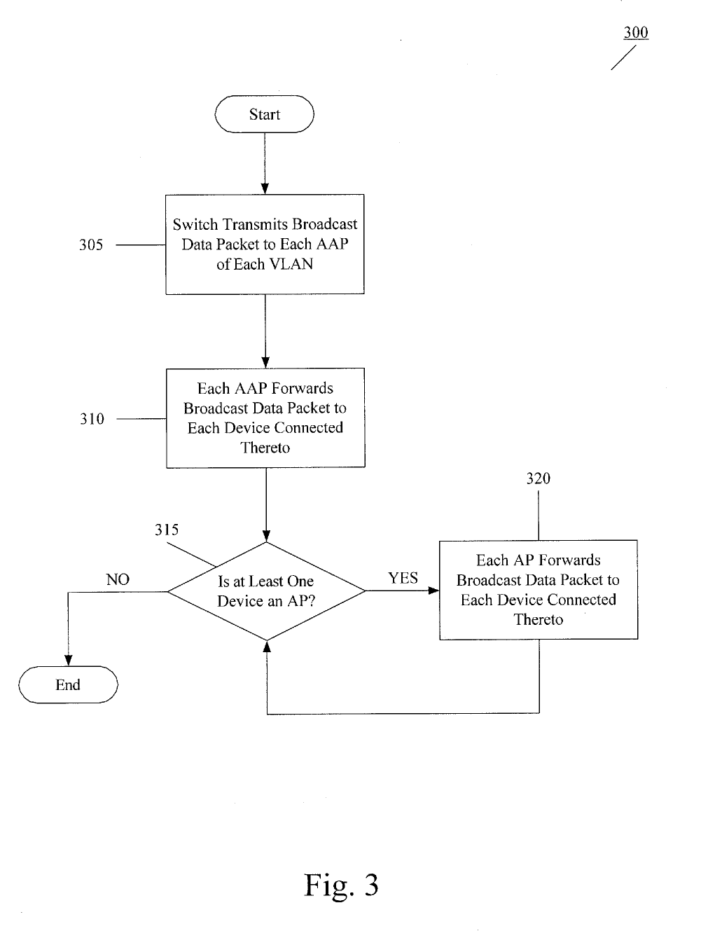

FIG. 3 shows a method 300 of transmitting data through the switched network of FIG. 1 according to an exemplary embodiment of the present invention. The method 300 will be described with reference to the system 100 of FIG. 1, the WAN 200 of FIG. 2, and the components therein. It should be noted that the method 300 may apply to any network configuration. That is, the method 300 may be utilized for a daisy chain network configuration, a mesh network configuration, a combination thereof, etc. For example, the system 100 and the WAN 200 of FIGS. 1-2, respectively, illustrate a daisy chain network configuration. As will be described below, the method 300 may be applied thereto. In another example, the method 300 may be applied to a mesh network configuration. In the mesh network, the base bridge may be used as the data path into the network from the switch to the AAP. The base bridge may also be utilized as the control path for the various APs disposed in the WAN.

In step 305, the switch transmits broadcast data packets to each AAP of each VLAN in the WAN using the WAN data path (VPN tunnel). For example, in the system 100, the switch 120 may transmit the broadcast data packets to the AAP 125, thereby to the VLAN 121, using the WAN data path. In another example, in the WAN 200, the switch 120 may transmit the broadcast data packets to the AAP 215, thereby to the VLAN 205 and to the AAP 220, thereby to the VLAN 220. It should be noted that a single VLAN may have multiple AAPs.

In step 310, each AAP forwards the broadcast data packets to each device connected thereto. For example, in the system 100, the AAP 125 may forward the broadcast data packets to the APs 130, 135, the MUs 145, 150, and the local device 140. In another example, in the WAN 200, the AAP 215 may forward the broadcast data packets to the APs 225, 230 while the AAP 220 may forward the broadcast data packet to the APs 235, 240. In either example, the AAP may forward the broadcast data packets to the APs using the LAN data path.

In step 315, a determination is made whether at least one of the devices connected to the AAP is an AP. For example, in the system 100, the APs 130, 135 are further connected to the AAP 125. In another example, in the WAN 200, the APs 225, 230 are further connected to the AAP 215 while the APs 235, 240 are further connected to the AAP 220.

If a determination is made that APs are connected to the AAP, the method 300 continues to step 320. In step 320, each AP forwards the broadcast data packets to each device connected thereto. For example, in the system 100, the AP 130 forwards the broadcast data packets to the MUs 155-165 while the AP 135 forwards the broadcast data packets to the MU 170. In another example, in the WAN 200, the APs 225-240 may further forward the broadcast data packets to any device connected thereto. Thus, if MUs are connected to any of the APs 22-240, the MUs would receive the broadcast data packets in this manner. Furthermore, if a local device is connected to any of the APs 225-240, the local device would receive the broadcast data packets in this manner.

After completing step 320, the method 300 returns to step 315 where another determination is made whether any device that received the broadcast data packets is an AP. Specifically, the return to step 315 from step 320 is used as a determination of whether any further forwarding device has received the broadcast data packet. For example, in the VLAN 121, either AP 130, 135 may be further connected to another AP. The further AP may have at least one other device connected thereto. Thus, AP 130, 135 may forward the broadcast data packets to the further AP which then forwards the broadcast data packets to its connected devices. In another example, the MU 155 may receive the broadcast data packets from the AP 130. Another MU may be connected to the MU 155 (e.g., infrared radio connection). Thus, the MU 155 may also be a forwarding device in addition to a receiving device. Once no further forwarding devices receive the broadcast data packets (i.e., negative determination of step 315), then the method 300 ends.

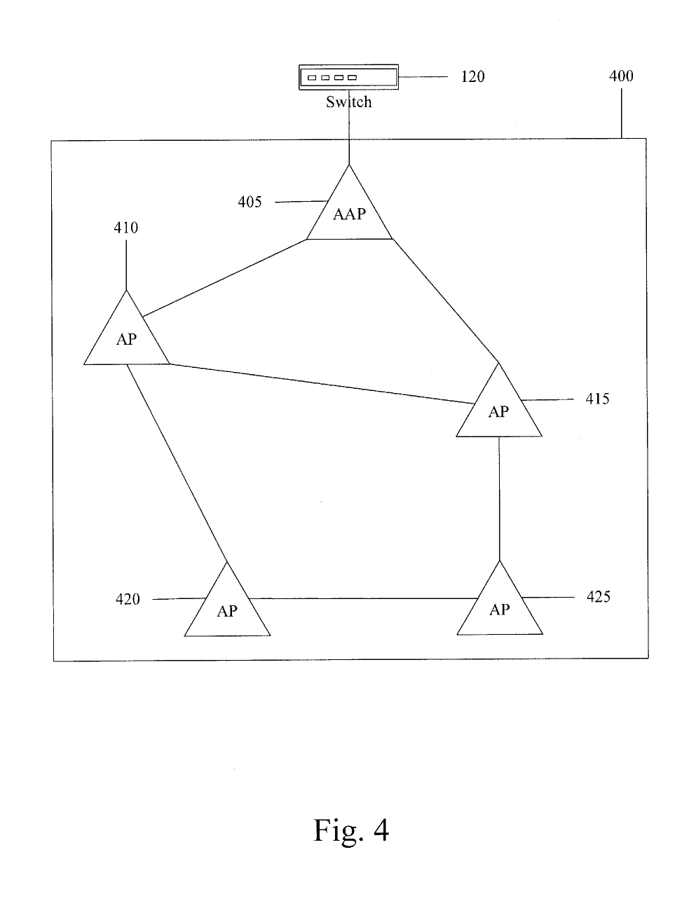

As discussed above, the exemplary embodiments and the exemplary method 300 of the present invention may be applied to any network topology. The above described exemplary embodiments illustrate a network topology that is a daisy chain. The exemplary embodiments may also be applied to a mesh topology. FIG. 4 shows a mesh topology for a switched network according to an exemplary embodiment of the present invention. The mesh topology is embodied as a VLAN 400. The VLAN 400 includes an AAP 405 and APs 410-425.

With regard to the mesh topology, the AAP 405 may be designated as an AP that includes a wired connection to the switch 120. As discussed above, the wired connection to the switch 120 may include the data path and the control path. That is, the wired connection to the switch 120 may be the VPN tunnel. The APs 410-425 may be disposed in the VLAN 400 as a substantial mesh. That is, the APs 410-425 may be connected within the VLAN 400 in any number of configurations. As illustrated, the AP 410 is connected to the AAP 405. The AP 410 is also connected to the APs 415-420. The AP 415 is also connected to the AAP 405. The AP 415 is also connected to the AP 425. The AP 420 is also connected to the AP 425. It should be noted that the above mesh configuration is a partially connected mesh network. That is, the APs are connected to more than one other AP using, for example, a point-to-point link. However, the VLAN 400 may also be a fully connected mesh network in which each AP is connected to every other AP using, for example, a point-to-point link.

The exemplary method 300 may also be applied to the VLAN 400 which has a mesh topology. For example, the switch 120 may transmit a broadcast data packet to the AAP 405. It should be noted that other embodiments may include APs in addition to the AAP 405 physically connected to the switch 120. However, only a single AP is designated as the AAP 405. However, the additional APs that are connected to the switch 120 receive the broadcast data packet through the mesh network after the AAP 405 receives the packet. It should also be noted that the APs of the mesh network may make the determination as to which AP becomes the AAP. This determination may follow a stipulation that the AP that becomes the AAP includes a physical connection to the switch 105. If the designated AAP becomes inoperable, then another AP that has a physical connection to the switch 120 may be designated as the AAP. This determination may be made by the APs or a media access control (MAC) address may be used where the next lowest MAC address becomes the AAP.

In contrast to the daisy chain topology, an AP may be connected to more than one other AP. For example, the AP 415 is connected to the AAP 405 and the APs 410, 425. As discussed above with the daisy chain topology, a substantial linear configuration exists so that a hierarchy for the forwarding of the broadcast data packet is established. Thus, with the mesh topology, a base bridge AP in which the client bridge is connected becomes the client bridge's path to the AAP.

The APs 410-425 may be configured with a spanning tree protocol (STP). The STP may tear down any redundant links between any two given APs participating in the mesh topology. This may be accomplished based on a received signal strength indicator (RSSI) values of the wireless connections between the APs. Accordingly, at any given time, there is just one link between any two given APs. The RSSI value and the base bridge load determine the best RF connection to the base bridge. A highest priority is assigned to the best link (e.g., high RSSI) while a lowest priority is assigned to the worst link (e..g., low RSSI). However, it should be noted that any link with a worse link than the best link may still be maintained for extraneous cases such as an active connection becoming inoperable. STP may configure the AP so that other paths are blocked to maintain a single link between any two given APs. STP of the APs 410-425 may thus be responsible for the distribution of the broadcast data packet in the mesh topology so that redundant transmissions of the same packet are prevented.

Returning to the mesh topology for the VLAN 400 of FIG. 4, the RSSI values may indicate that the links between the AAP 405 to the APs 410, 415 are highest; the link between the AP 410 to the AP 420 is highest; the link between the AP 415 to the AP 425 is highest. STP therefore blocks the other links when a broadcast data packet is transmitted. Thus, as is always the case according to the exemplary embodiments of the present invention, a broadcast data packet from the switch 120 first gets forwarded to the AAP 405. Subsequently, following the exemplary method 300, the packet is forwarded from the AAP 405 to the APs 410, 415. Then the packet is forwarded from the AP 410 to only the AP 420. The packet is also forwarded from the AP 415 to only the AP 425. In this manner, the AAP architecture of the exemplary embodiments of the present invention may also be applied to a mesh topology.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

1. A system, comprising:
a switch disposed within a network, the network comprising at least one virtual local area network;
an anchor access point disposed in the at least one virtual local area network, the anchor access point connected to the switch via a data path, the anchor access point configured to receive a broadcast data packet from the switch via the data path; and
at least one access point connected to the anchor access point via a local data path to receive the broadcast data packet from the anchor access point via the local data path, the anchor access point and the access points further forwarding the broadcast data packet to other devices connected thereto, wherein the at least one access point is connected to the switch via a first control path and the anchor access point is connected to the switch via a second control path.

2. (canceled)

3. The system of claim 1, wherein the anchor access point and the at least one access point are configured to transmit at least one of configuration and statistics packets to the switch via the corresponding control paths.

4. The system of claim 1, wherein the other devices include at least one further access point connected to the at least one access point.

5. The system of claim 4, wherein the at least one further access point is connected to the switch via a further control path to transmit at least one of configuration and statistics packets to the switch.

6. The system of claim 1, wherein the other devices include at least one mobile unit communicating wirelessly with the anchor access point.

7. The system of claim 1, wherein the other devices include at least one local device.

8. The system of claim 7, wherein the at least one local device includes at least one of a printer, a workstation, a fax machine, a telephone, and a scanner.

9. The system of claim 1, wherein the data path is a virtual private network tunnel.

10. A method, comprising:
transmitting, from a switch, a broadcast data packet to an anchor access point of a network, the anchor access point being included in a virtual local area network, the virtual local area network being a part of the network; and
forwarding, from the anchor access point, the broadcast data packet to devices connected thereto, wherein the anchor access point is connected to the switch via a first control path and each of the devices are connected to the switch via a second control path.

11. The method of claim 10, wherein, when any of the devices are access points, forwarding the broadcast data packet to other devices connected thereto.

12. (canceled)

13. The method of claim 11, wherein the anchor access point and the access points are configured to transmit at least one of configuration and statistics packets to the switch via the corresponding control paths.

14. The method of claim 11, wherein at least one further access point is connected to one of the at least one access point.

15. The method of claim 14, wherein the at least one further access point includes a further control path to the switch.

16. The method of claim 10, wherein the devices include at least one mobile unit communicating wirelessly with the anchor access point.

17. The method of claim 10, wherein the devices include at least one local device.

18. The method of claim 17, wherein the at least one local device includes at least one of a printer, a workstation, a fax machine, a telephone, and a scanner.

19. A system, comprising:
a switch disposed within a network, the network comprising at least one virtual local area network;
an intermediary forwarding means for receiving a broadcast data packet from the switch via a data path, the intermediary forwarding means disposed in the at least one virtual local area network; and
at least one access point connected to the intermediary forwarding means with a local data path to receive the broadcast data packet from the intermediary forwarding means via the local data path, the intermediary forwarding means and the access points further forwarding the broadcast data packet to other devices connected thereto, wherein the intermediate forwarding means is connected to the switch via a first control path and each of the devices are connected to the switch via a second control path.

20. An anchor access point, comprising:
a first connector connecting the anchor access point to a switch, the first connector establishing a data path to the switch to receive a broadcast data packet;
a second connector connecting the anchor access point to the switch, the second connector establishing a control path to the switch to transmit one of configuration and statistics packets to the switch; and
at least one further connector connecting the anchor access point to other devices, the at least one further connector establishing a local data path to transmit the broadcast data packet to the other devices.

21. A system, comprising:
an anchor access point configured to be connected via a data path to a packet distribution means and a separate anchor access port control path to the packet distribution means, wherein the anchor access point receives a broadcast data packet from the packet distribution means; and
a plurality of access points, each access point configured to be connected one of directly and indirectly to the anchor access point via a local data path and a separate access point control path to the packet distribution means, wherein the anchor access point transmits the broadcast data packet to each access point via the corresponding local data path.

22. The system of claim 21, wherein each of the access points having an indirect local data path is via another of the access points.

23. The system of claim 21, wherein the anchor access point and the access point transmit control packets to the packet distribution means via the corresponding control path.
